(19) United States
(12) Patent Application Publication
(10) Pub. No.: US 2008/0299342 A1
(43) Pub. Date: Dec. 4, 2008

(54) Catalyst Comprising Chromium and Zinc for Olefin Polymerization and Process for Preparing It

(75) Inventors: Martin Schneider, Kelkeim (DE); Jan Gohre, Dusseldorf (DE); Rainer Karer, Kaiserlautern (DE); Wolfgang Rohde, Speyer (DE); Anke Bold, Dirmstein (DE); Martin Lux, Schwarzenbach (DE); Ernst Fischer, Speyer (DE); Christoph Kiener, Weisenheim (DE)

Correspondence Address: Basell USA Inc., Delaware Corporate Center II, 2 Righter Parkway, Suite #300, Wilmington, DE, 19803, US

(73) Assignee: BASELL POLYOLEFINE GMGH, WESSELING GERMANY (DE)

(21) Appl. No.: 11/628,682

(22) PCT Filed: Jun. 9, 2005
(86) PCT No.: PCT/EP05/52672

§ 371 Date: Dec. 6, 2006

Related U.S. Application Data
(60) Provisional application No. 60/588,699, filed on Jul. 16, 2004.

(30) Foreign Application Priority Data
Jun. 16, 2004 (DE) 10-2004-028-779.1

(51) Int. Cl. B32B 1/08; B01J 23/06; B01J 23/26; C08F 4/44

(52) U.S. Cl. 428/36.9; 502/307; 502/171; 526/108; 502/201

(57) ABSTRACT

Catalyst for the polymerization and/or copolymerization of olefins which has a chromium content of from 0.01 to 5% by weight, based on the element in the finished catalyst, is supported on a finely divided inorganic support and is obtainable by concluding calcination at temperatures of from 350 to 1050° C. and has a zinc content of from 0.01 to 10% by weight, based on the element in the finished catalyst.

The invention relates to a catalyst for the polymerization and/or copolymerization of olefins which has a chromium content of from 0.01 to 5% by weight, based on the element in the finished catalyst, is supported on a finely divided inorganic support and is obtainable by concluding calcination at temperatures of from 350 to 1050° C.

Catalysts of the type mentioned have long been customary in olefin polymerization under the name Phillips catalysts. These chromium(VI) catalysts are generally based on silica gel supports to which the chromium component is applied and is chemically fixed as chromium(VI) on the support surface by calcination at temperatures of from 350 to 1050° C. in an air or oxygen atmosphere.

In place of silica gel supports, the literature has described porous AlPO₄ supports, combinations of such supports with silica gels, aluminum or titanium cogels and also surface-modified silica gels. Surface modification is usually carried out using metal salts, metal alkyls or metal alkoxides which are converted on the support surface into the corresponding metal oxides during the calcination without leaving a residue.-This process is employed mainly for surface modification with titanium.

The surface modifications serve to influence the polydispersity M_{w}/Mₙ of the molar mass distribution of the products produced using these catalysts. Thus, modification with titanium results, depending on the calcination temperature, in a broadening of the molar mass distribution.

Relatively broad molar mass distributions frequently have a favorable effect on the process properties of the polymers. Thus, increasing the polydispersity enables polyethylenes of medium density (MDPE) and high density (HDPE) to be processed with a long neck to produce blown film having improved mechanical properties, in particular puncture resistance. Furthermore, high polydispersities are also advantageous for blown film processing in that, firstly, they reduce the melt pressure in the extruder as a result of a higher pseudoplasticity and, secondly, they improve the parison stability. This is an important processing parameter which is not determined sufficiently well by the polydispersity alone. Thus, examples of labile film tubes having poor tolerances in the flow direction are found again and again, even though the polymer product from which the film is produced has a high polydispersity.

In the case of hollow bodies made of polyethylene having a broad molar mass distribution, the environmental stress cracking resistance (ESCR) usually increases. This is desirable, although the shock resistance is reduced as the polydispersity increases (M. FleiBner, Angew. Makromolekulare Chemie, 105, 167-185 (1982)) and swelling during extrusion of the molding increases.

The use of the element zinc in the form of alkyl compounds in olefin polymerization is known, for example, from DE-A 41 39 256.

Furthermore, SU 1031969 A1 discloses an in-situ copolymerization using a ZnCl₂/Al-alkyl mixture. The latter is mixed separately, presumably forming zinc alkyls, before being brought into contact with the monomer.

However, use of the element zinc as constituent of a modification of Phillips catalysts has not been described hitherto.

It is therefore an object of the present invention to overcome the abovementioned disadvantages of the prior art and to provide a Phillips catalyst by means of which it is possible to produce blown films which have a high puncture resistance and during processing display a high parison stability, and also hollow bodies which have a high environmental stress cracking resistance together with a high shock resistance.

It has surprisingly been found that this can be achieved by a catalyst of the type mentioned at the outset which has a zinc content of from 0.01 to 10% by weight.

The present invention shows that chromium(VI) catalysts when modified with zinc produce olefin polymers, in particular ethylene polymers, which at a relatively narrow molar mass distribution give high puncture resistances and a high parison stability in film applications. The high parison stability in particular was not able to be achieved using any of the catalysts employed for comparison. Furthermore, despite a relatively narrow molar mass distribution, these products have a high environmental stress cracking resistance (ESCR). These catalysts thus make it possible to produce products which combine a high environmental stress cracking resistance and a high shock resistance, as are desired for hollow bodies.

An important aspect of the catalyst of the invention is, firstly, that the chromium content is from 0.01 to 5% by weight, preferably from 0.1 to 2% by weight, particularly preferably from 0.2 to 1% by weight, and the zinc content is from 0.01 to 10% by weight, preferably from 0.1 to 7% by weight, particularly preferably from 0.5 to 3% by weight. The chromium and zinc contents are in this case the ratio of the mass of the respective element to the total mass of the finished catalyst.

In an embodiment of the present invention, chromium and zinc are present in the catalyst of the invention in supported form on a finely divided inorganic support. One constituent of the chromium catalyst of the invention is therefore the finely divided inorganic support material, in particular an inorganic solid which is usually porous. Preference is given to oxidic support materials which may still contain hydroxy groups. The inorganic metal oxide can be spherical or granular. Examples of solids of this type, which are known to those skilled in the art, are aluminum oxide, silicon dioxide (silica gel), titanium dioxide or their mixed oxides or cogels, or aluminum phosphate. Further suitable support materials can be obtained by modifying the pore surface area, e.g. by means of compounds of the elements boron (BE-A-61,275), aluminum (U.S. Pat. No. 4,284,527), silicon (EP-A 0 166 157) or phosphorus (DE-A 36 35 715). Preference is given to using a silica gel. Preference is given to spherical or granular silica gels and also silica-based cogels.

The zinc is preferably deposited on the surface of the support, with the term “surface” in this context referring both to the external surface and also, in particular, the internal surface in the pores of the support.

In a further embodiment of the present invention, the zinc can also be incorporated into the matrix of the support material as constituent of a cogel. Here too, preference is given to cogels which are based on silica.

Finally, zinc compounds can be additionally supported on zinc-containing cogels.

An important aspect of the catalyst of the invention is that a concluding calcination at temperatures of from 350 to 1050° C. is carried out. For the purposes of the present invention, “concluding” means that the calcination is carried out on the support after it has finished being doped, i.e. after application of the chromium compound and the zinc compound to the support, with further after-treatments of the calcined catalyst, for example reduction of the Cr(VI) by means of CO or the like, not being ruled out. Furthermore, it should not be ruled out that the application of the zinc compound occurs only in the furnace used for the calcination, with the addition of the zinc compound always taking place at below the actual final calcination temperature.

The present invention further provides a preferred process for preparing the specified catalysts, which comprises the steps:
a) preparing an inorganic, finely divided support,
b) applying a solution or suspension of a zinc compound to the support,
c) applying a solution or suspension of a chromium compound to the support,
d) if appropriate, drying the support,
e) calcining the support at temperatures of from 350 to 1050° C., preferably from 400 to 850° C.

A particularly preferred process consists of the abovementioned steps, if appropriate with an optional step b′) consisting of drying of the catalyst between step b) and c).

In step a), a finely divided inorganic and porous support is prepared. In an alternative procedure, the steps a) and b) are altered in that the zinc is not applied subsequently but instead a zinc-containing cogel is prepared in one step.

The preparation of the support is not restricted to a particular method. Rather, all known preparative methods can be used for preparing the support for the catalyst of the invention.

The supports of the catalyst of the invention have a mean pore diameter which is generally below 4000 nm preferably in the range below 200 nm (2000 Å); the support partides preferably have a pore diameter in the range below 160 nm (1600 Å), particularly preferably in the range from 5 nm (50 Å) to 60 nm (600 Å), very particularly preferably in the range from 5 to 20 nm.

In general, the mean partide diameter of the support particles is in the range from 1 to 10,000 μm. The particle diameters quoted here are the diameters of the porous particle as can be determined by sieving, light scattering or image analysis. Support particles which can preferably be used for polymerization in slurry polymerization processes can preferably have mean particle sizes up to 350 μm; they preferably have a mean particle size in the range from 30 μm to 150 μm. Support particles which can preferably be used for polymerization in gas-phase fluidized-bed processes preferably have a mean particle size in the range from 30 μm to 300 μm, more preferably in the range from 40 μm to 100 μm, particularly preferably in the range from 40 μm to 80 μm. Support particles which can preferably be used for polymerization in suspension processes preferably have a mean particle size in the range from 30 μm to 350 μm, preferably in the range from 40 μm to 100 μm. Support particles which can preferably be used for polymerization in loop processes preferably have a mean particle size in the range from 30 μm to 150 μm. Support particles which can, for example, be used for polymerization in fixed-bed reactors advantageously have mean particle sizes of 24 100 μm, preferably 24 300 μm, more preferably in the range from 1 mm to 10 mm, particularly preferably in the range from 2 mm to 8 mm and even more preferably in the range from 2.5 mm to 5.5 mm.

The mean pore volume of the support material used is in the range from 0.1 to 10 ml/g, in particular from 0.8 to 4.0 ml/g and particularly preferably from 1 to 3.0 ml/g.

In general, the support particles have a specific surface area of from 10 to 1000 m²/g, in particular from 100 to 600 m²/g, particularly preferably from 200 to 550 m²/g.

The surface area of the inorganic support can likewise be varied within a wide range by means of the drying process, in particular the spray drying process. Preference is given to producing particles of the inorganic support, in particular a product from a spray dryer, which have a surface area in the range from 100 m²/g to 1000 m²/g, preferably in the range from 150 m²/g to 700 m²/g and particularly preferably in the range from 200 m²/g to 500 m²/g. The specific surface area of the support particles is based on the pore surface area of the support particles. The specific surface area and the mean pore volume are determined by nitrogen adsorption using the BET method as described, for example, in S. Brunauer, P. Emmett and E. Teller in Journal of the American Chemical Society, 60, (1939), pages 209-319. The mean pore diameter is four times the ratio of pore volume to pore surface area.

The apparent density of the inorganic supports for catalysts is generally in the range from 30 g/l to 2000 g/l, preferably in the range from 100 g/l to 1200 g/l, with the apparent density being able to vary as a function of the water content of the support. The apparent density of water-containing support particles is preferably in the range from 200 g/l to 1500 g/l, more preferably in the range from 600 g/l to 1200 g/l and particularly preferably in the range from 650 g/l to 1100 g/l. In the case of supports which contain very little if any water, the apparent density is preferably from 100 g/l to 600 g/l.

Suitable support materials are commercially known and available or can be prepared by methods described in the prior art.

Preferred support materials are finely divided silica xerogels which can be prepared as described, for example, in DE-A 25 40 279. The finely divided silica xerogels are preferably prepared by:
A) taking a particulate silica hydrogel which has a solids content (calculated as SiO₂) of from 10 to 25% by weight and is largely spherical and has a particle diameter of from 1 to 8 mm and is obtained by
   A1) introducing a sodium or potassium water glass solution into a rotating stream of an aqueous mineral acid, both longitudinally and also tangentially to the stream,
   A2) spraying the resulting silica hydrosol as droplets into a gaseous medium,
   A3) allowing the sprayed hydrosol to solidify in the gaseous medium,
   A4) freeing the resulting largely spherical particles of the hydrogel of salts by washing, with or without prior aging,
B) optionally milling the hydrogel,
C) optionally extracting at least 60% of the water present in the hydrogel by means of an organic liquid,
D) drying the resulting gel, e.g. at up to 180° C. and a reduced pressure of 13 mbar for 30 minutes, until no further weight loss occurs (xerogel formation) or by means of flow drying or spraying drying and
E) setting the particle diameter of the xerogel obtained to from 20 to 2000 μm.

In the first step A) of the preparation of the support material, it is important to use a silica hydrogel which has a relatively high solids content of from 10 to 25% by weight (calculated as SiO₂), preferably from 12 to 20% by weight, particularly preferably from 14 to 20% by weight, and is largely spherical. The steps A1) to A3) are described in more detail in DE-A 21 03 243. Step A4), viz. washing of the hydrogel, can be carried out in any desired way, for example according to the countercurrent principle using water having a temperature of up to 80° C., with additions of ammonia or ammonium nitrate or carbon dioxide (pH values up to about 10) being able to be added to the wash water. Acid-stable metal compounds can also be added to the aqueous mineral acid required for predpitation, so as to lead to the formation of the abovementioned silica cogels. Examples of such metal compounds are titanyl sulfate and zinc sulfate or zinc nitrate, which lead to the zinc-containing catalysts of the invention.

The optional milling (step B) of the hydrogel leads to an aqueous slurry which is preferably derived directly, i.e. without prior extraction.

The optional extraction of the water from the hydrogel (step C)) is preferably carried out using an organic liquid which is particularly preferably miscible with water and is selected from the group consisting of C₁-C₄-alcohols and C₃-C₅-ketones. Particularly preferred alcohols are tert-butanol, i-propanol, ethanol and methanol. Among the ketones, acetone is preferred. The organic liquid can also consist of mixtures of the abovementioned organic liquids, and in any case the organic liquid contains less than 5% by weight, preferably less than 3% by weight, of water prior to the extraction. The extraction can be carried out in customary extraction apparatuses, e.g. column extractors. An alternative extractive dewatering can be carried out by azeotropic distillation, e.g. using a hydrocarbon.

In the case of the extracted hydrogels, drying (step D)) is preferably carried out at temperatures of from 30 to 200° C., particularly preferably from 80 to 180° C., and at pressures of preferably from 1.3 mbar to atmospheric pressure. Here, because of the vapor pressure, a rising temperature should be accompanied by a rising pressure and vice versa. In the case of milled hydrogel slurries, customary flow or spray drying processes are used, and these are preferably carried out at ambient pressure and temperatures of up to 300° C.

The particle diameter of the xerogel obtained can be set (step E)) in any desired way, e.g. by milling and sieving.

A preferred support material is prepared, inter alia, by spray drying milled, appropriately sieved hydrogels which are for this purpose mixed with water or an aliphatic alcohol. The primary particles are porous, granular particles of the appropriately milled and sieved hydrogel having a mean partide diameter of from 1 to 20 μm, preferably from 1 to 5 μm. Preference is given to using milled and sieved SiO₂ hydrogels.

Further advantageous supports can be prepared from a hydrogel by means of the steps
i) preparing a hydrogel;
ii) milling the hydrogel to give a finely particulate hydrogel in which at least 5% by volume of the particles, based on the total volume of the particles, have a particle size in the range from >0 μm to ≦3 μm; and/or at least 40% by volume of the particles, based on the total volume of the particles, have a particle size in the range from >0 μm to ≦12 μm, and/or at least 75% by volume of the particles, based on the total volume of the particles, have a particle size in the range from >0 μm to ≦35 μm;
iii) producing a slurry based on the finely particulate hydrogel;
iv) drying the slurry comprising the finely particulate hydrogel to give the support for catalysts,
   as described in more detail in the German patent application DE 102004006104.

The size of hydrogel particles which can be used can vary in a wide range, for example in a range from a few microns to a few centimeters. The size of hydrogel particles which can be used is preferably in the range from 1 mm to 20 mm, but hydrogel cakes can likewise be used. It can be advantageous to use hydrogel particles which have a size in the range ≦6 mm. These are obtained, for example, as by-product in the milling of hydrogels in the production of granular supports.

Hydrogels which can be prepared according to step i) are preferably largely spherical. Hydrogels which can be prepared according to step i) also preferably have a uniform surface. Silica hydrogels which can be prepared according to step i) preferably have a solids content in the range from 10% by weight to 25% by weight, preferably in the region of 17% by weight, calculated as SiO₂.

In step ii), a finely particulate hydrogel having a solids content in the range from >0% by weight to ≦25% by weight, preferably from 5% by weight to 15% by weight, more preferably in the range from 8% by weight to 13% by weight, particularly preferably in the range from 9% to weight to 12% by weight, very particularly preferably in the range from 10% by weight to 11% by weight, calculated as oxide, is preferably produced. A finely particulate silica hydrogel having a solids content in the range from >0% by weight to ≦25% by weight, preferably from 5% by weight to 15% by weight, more preferably in the range from 8% by weight to 13% by weight, particularly preferably in the range from 9% by weight to 12% by weight, very particularly preferably in the range from 10% by weight to 11% by weight, calculated as SiO₂, is particularly preferably produced in step ii). The solids content is preferably set by dilution, for example by addition of deionized water.

The hydrogel is milled to a finely particulate hydrogel, with the hydrogel being milled to very fine particles according to the invention.

The advantages of the support which can be prepared from milled hydrogel particles are that the support preferably has a compact microstructure. Without being tied to a particular theory, it is assumed that the hydrogel particles according to the invention can pack together in a high packing density in the formation of the support.

Catalyst systems comprising supports which can be prepared from hydrogel particles which can be produced according to step ii) advantageously have a particularly good productivity.

The finely particulate hydrogel has a preferred distribution of the particle sizes when at least 75% by volume, preferably at least 80% by volume, more preferably at least 90% by volume, of the hydrogel particles, based on the total volume of the particles, have a particle size in the range from >0 μm to ≦35 μm, with preference in the range from >0 μm to ≦30 μm, with greater preference in the range from >0 μm to ≦25 μm, preferably in the range from >0 μm to ≦20 μm, more preferably in the range from >0 μm to ≦18 μm, even more preferably in the range from >0 μm to ≦16 μm, particularly preferably in the range from >0 μm to ≦15 μm, more particularly preferably in the range from >0 μm to ≦14 μm, very particularly preferably in the range from >0 μm to ≦13 μm, especially in the range from >0 μm to ≦12 μm, more especially in the range from>0μm to ≦11 μm.

The supports which can be produced from the abovementioned hydrogel particles have a high homogeneity. A high homogeneity of the support can lead to the application of a catalyst to the support likewise being able to be carried out with high homogeneity and the polymerization products being able to have relatively high molecular weights. This leads to particularly advantageous catalysts, especially in combination with a single-stage application of chromium and zinc to the support.

Suitable inorganic hydroxides, oxide-hydroxides and/or oxides are, for example, selected from the group consisting of hydroxides, oxide-hydroxides and oxides of silicon, aluminum, titanium, zirconium and one of the metals of main groups I and II of the Periodic Table and mixtures thereof. Zinc oxide or other zinc-containing oxides, hydroxides or mixed oxides can also serve as additive, which leads to a catalyst according to the present invention.

The support particles produced in step a) particularly advantageously have a low fines content after drying, in particular after spray drying. For the purposes of the present invention, the fines content of the support particles is the proportion of support particles which have a particle size of less than 25 μm, preferably less than 22 μm, particularly preferably less than 20.2 μm. It is advantageous for less than 5% by volume of the particles after drying, based on the total volume of the particles, to have a particle size in the range from >0 μm to ≦25 μm, preferably in the range from >0 μm to ≦22 μm, particularly preferably in the range from >0 μm to ≦20.2 μm. Preference is given to less than 3% by volume, particularly preferably less than 2% by volume, of the particles, based on the total volume of the particles, having a particle size in the range from >0 μm to ≦25 μm, preferably in the range from >0 μm to ≦22 μm, particularly preferably in the range from >0 μm to ≦20.2 μm. It is preferred that less than 5% by volume, preferably less than 2% by volume, of the particles, based on the total volume of the particles, have a particle size in the range from >0 μm to ≦10 μm.

In the steps b) and c), the compounds of the elements zinc and chromium are applied, and it should be emphasized that the steps b) and c) can be carried out simultaneously or in succession in any order. The zinc compound and the chromium compound are preferably applied simultaneously.

The weight ratio of the chromium compounds and the zinc compound to the support during application to the support is in each case preferably in the range from 0.001:1 to 200:1, more preferably in the range from 0.005:1 to 100:1, particularly preferably from 0.1 to 10, in particular from 0.2 to 5. The amount of solution used during doping in steps b) and c) is preferably smaller than the pore volume of the support.

The application of the zinc compound in step b) can, firstly, be carried out by impregnating the support material with the zinc salt and drying the support so that the zinc salt remains on the pore surfaces of the support. However, the zinc compound can also be precipitated within the pores as zinc hydroxide before drying by means of basic additions such as sodium hydroxide or ammonia.

In this case, it is advisable to match the solution volume precisely to the pore volume, so that precipitates outside the pores are avoided.

Furthermore, suitable volatile zinc compounds can also be mixed dry with the support and adsorbed on the support via the gas phase, if appropriate with heating.

It is also possible for suitable zinc compounds to be introduced dry as a solution into the furnace in which the catalyst precursor is placed and which is used for catalyst activation. The zinc is then bound to the catalyst during the calcination of the catalyst.

Zinc compounds which can be used in step b) are all organic or inorganic compounds of this element which are readily soluble in the chosen solvent. The compounds include chelates of the elements. Preferred zinc compounds are selected from the group consisting of Zn(NO₃)₂ and Zn(acac)₂, with particular preference being given to Zn(NO₃)₂. It is also possible to use zinc alkyl compounds, e.g. diethylzinc.

The application of the chromium compound in step c) is preferably carried out from a solution in a suitable solvent. The amount of solvent used should be such that it is at least one tenth of the pore volume of the support. Preference is given to amounts of solvent greater than half the available pore volume of the support. Dry mixing of suitable volatile chromium compounds with the support is also possible, with adsorption of the chromium component occurring via the gas phase, if appropriate with heating. In a specific variant of this method, the mixture is heated in the furnace utilized for catalyst activation.

In step c), it is possible to use chromium compounds in all valence states. Preference is given to using chromium compounds having a valence of three or six, particularly preferably three. Compounds of this type include, for example, chromium hydroxide and soluble trivalent chromium salts of an organic or inorganic acid, e.g. acetates, oxalates, sulfates or nitrates. Particular preference is given to salts of acids which during calcination in an oxidizing atmosphere are converted essentially into chromium(VI) without leaving a residue, e.g. chromium(III) nitrate nonahydrate. Furthermore, chelate compounds of chromium, e.g. chromium derivatives of β-diketones, β-ketoaldehydes or β-dialdehydes, and/or complexes of chromium, e.g. chromium(III) acetylacetonate or chromium hexacarbonyl, or organometallic compounds of chromium, e.g. bis(cyclopentadienyl)chromium(II), organic chromic(VI) esters or bis(arene)chromium(0), can likewise be used.

When the steps b) and c) are carried out simultaneously, particular preference is given to the solution used in steps b) and c) containing both the chromium compound and the zinc compound. In other words, the chromium and zinc compounds are applied to the support from a single uniform solution.

When the chromium and zinc compounds are applied separately, an additional drying step (step b′) can be carried out between the two application steps b) and c). This is particularly useful when different solvents are employed for the two steps.

Suitable solvents for the application of the chromium and zinc compounds in the steps b) and c) include both protic and aprotic, polar and nonpolar solvents. Preference is given to protic or aprotic organic solvents. Particular preference is given to protic organic solvents. Further particular preference is given to organic polar aprotic solvents.

For the purposes of the present invention, a protic solvent is a solvent or solvent mixture which comprises from 1 to 100% by weight, preferably from 50 to 100% by weight and particularly preferably 100% by weight, of a protic solvent or a mixture of protic solvents and from 99 to 0% by weight, preferably from 50 to 0% by weight and particularly preferably 0% by weight, of an aprotic solvent or a mixture of aprotic solvents, in each case based on the protic medium.

Protic solvents are, for example, alcohols R¹—OH, amine NR¹₂₋ₓHₓ₊₁, C₁-C₅-carboxylic acids and inorganic aqueous acids such as dilute hydrochloric acid or sulfuric acid, water, aqueous ammonia or mixtures thereof, preferably alcohols R¹—OH, where the radicals R¹ are each, independently of one another, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR²₃, the radicals R² are each, independently of one another, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part and x is 1 or 2. Possible radicals R¹ or R² are, for example, the following: C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₆-C₁₀-aryl group as substituent, e.g. cydopropane, cyclobutane, cyclopentane, cydohexane, cydoheptane, cyclooctane, cyclononane or cyclododecane, C₂-C₂₀-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₀-aryl which may bear further alkyl groups as substituents, e.g. phenyl, naphthyl, biphenyl, anthranyl, o-, m-, p-methylphenyl, 2,3-, 2,4-, 2,5-, or 2,6-dimethylphenyl, 2,3,4- 2,3,5-, 2,3,6-, 2,4,5-, 2,4,6- or 3,4,5-trimethylphenyl, or aralkyl which may bear further alkyl groups as substituents, e.g. benzyl, o-, m-, p-methylbenzyl, 1- or 2-ethylphenyl, where the two R¹ or two R² may in each case also be joined to form a 5- or 6-membered ring and the organic radicals R¹ and R² may also be substituted by halogens such as fluorine, chlorine or bromine. Preferred carboxylic acids are C₁-C₃-carboxylic acid such as formic acid or acetic acid. Preferred alcohols R1—OH are methanol, ethanol, 1-propanol, 2-propanol, 1-butanol, 2-butanol, 1-pentanol, 2-pentanol, 1-hexanol, 2-ethylhexanol, 2,2-dimethylethanol or 2,2-dimethylpropanol, in particular methanol, ethanol, 1-propanol, 1-butanol, 1-pentanol, 1-hexanol or 2-ethylhexanol. The water content of the protic medium is preferably less than 20% by weight.

Nonpolar aprotic solvents are, for example, aliphatic and aromatic hydrocarbons such as pentane, hexane, heptane, octane, isooctane, nonane, dodecane, cyclohexane, benzene and C₇-C₁₀-alkylbenzenes such as toluene, xylene or ethylbenzene.

Polar aprotic solvents are, for example, ketones, ethers, esters or nitriles, without being restricted thereto. These contain heteroatoms of groups 15 to 17, which produce a permanent dipole moment.

The chromium and zinc compounds are preferably applied from a from 0.05% strength by weight to 15% strength by weight solution of a chromium compound which is converted into chromium trioxide under the conditions of the activation or a nonhydrolyzing zinc compound in a C₁-C₄-alcohol, with the respective solvent preferably containing not more than 20% by weight of water. Furthermore, loading of the support without solvent, for example by mechanical mixing, is also possible.

The solution comprising the chromium compound and/or the zinc compound is preferably added to the support, but it is also possible for the support to be suspended in a solution comprising the appropriate chromium and/or zinc compound and the liquid constituents of the reaction mixture to be evaporated with continuous, very homogeneous mixing.

Apart from chromium and zinc, further transition metals such as titanium or zirconium can also be applied to the support. Preference is given to no further transition metals apart from chromium and zinc being applied.

After application of the chromium compound and the zinc compound to form a precatalyst, the support is optionally largely freed of the solvent in step d), if this is necessary for the subsequent calcination. This can, if appropriate, be carried out under reduced pressure and/or at elevated temperature.

The concluding calcination of the doped support (precatalyst) is carried out in step e) at temperatures of from 350 to 1050° C., preferably from 400 to 900° C. For the purposes of the present invention, calcination is the thermal activation of the catalyst in an oxidizing atmosphere, with the chromium compound applied being converted completely or partly into the hexavalent state. The choice of calcination temperature is determined by the properties of the polymer to be prepared and the activity of the catalyst. The upper limit is imposed by the sintering of the support and the lower limit is imposed by the activity of the catalyst coming too low. The influence of the calcination conditions of the catalyst are known in principle and are described, for example, in Advances in Catalysis, Vol. 33, page 48 ff.

The calcination is preferably carried out in a gas stream comprising water-free oxygen in a concentration of over 10% by volume, e.g. in air, at a temperature in the range from 350° C. to 1050° C., preferably in the range from 400° C. to 900° C., particularly preferably in the range from 500° C. to 850° C. The activation can be carried out in a fluidized bed and/or in a stationary bed. Preference is given to carrying out a thermal activation in fluidized-bed reactors.

The precatalysts can also be doped with fluoride. Doping with fluoride can be carried out during preparation of the support, application of the transition metal compounds (basic doping) or during activation. In a preferred embodiment of the preparation of the supported catalyst, a fluorinating agent is brought into solution together with the desired chromium and/or zinc compound in step b) or c) and the solution is applied to the support. Particular preference is given to simultaneous doping with the chromium, zinc and fluorine compounds.

In a further, preferred embodiment, doping with fluorine is carried out after the basic doping during the calcination step e) of the process of the invention. Fluoride doping is particularly preferably carried out together with the activation at temperatures in the range from 400° C. to 900° C. in air. A suitable apparatus for this purpose is, for example, a fluidized-bed activator.

Fluorinating agents are preferably selected from the group consisting of ClF₃, BrF₃, BrF₅, (NH₄)₂SiF₆ (ammonium hexafluorosilicate), NH₄BF₄, (NH₄)₂AlF₆, NH₄HF₂, (NH₄)₃PF₆, (NH₄)₂TiF₆ and (NH₄)₂ZrF₆. Preference is given to using fluorinating agents selected from the group consisting of (NH₄)₂SiF₆, NH₄BF₄, (NH₄)₂AlF₆, NH₄HF₂, (NH₄)₃PF₆. Particular preference is given to using (NH₄)₂SiF₆.

The fluorinating agent is generally used in an amount in the range from 0.5% by weight to 10% by weight, preferably in the range from 0.5% by weight to 8% by weight, particularly preferably in the range from 1% by weight to 5% by weight, very particularly preferably in the range from 1% by weight to 3% by weight, based on the total mass of the catalyst used. Preference is given to using from 2% by weight to 2.5% by weight, based on the total mass of the catalyst used. The properties of the polymers prepared can be varied as a function of the amount of fluoride in the catalyst.

Fluorination of the catalyst system can advantageously lead to a narrower molar mass distribution of the polymers obtainable by a polymerization than is the case in a polymerization by means of a nonfluorinated catalyst.

After the calcination, the calcined precatalyst can, if appropriate, be reduced, for example by means of reducing gases such as CO or hydrogen or suitable organic compounds such as internal olefins, aldehydes which are preferably brought into the gas phase, preferably at from 350 to 1050° C., to obtain the actual catalytically active species. However, the reduction can also be carried out only during the polymerization by means of reducing agents present in the reactor, e.g. ethylene, metal alkyls and the like.

The catalysts of the invention can be used, in particular, for the polymerization and/or copolymerization of olefins. The present invention therefore provides a process for preparing an ethylene polymer by polymerization of ethylene and, if appropriate, C₃-C₂₀-olefins as comonomers in the presence of the supported polymerization catalyst prepared according to the invention. Preferred comonomers are propene, butene, pentene, hexene, methylpentene, octene, in particular butene, hexene and octene.

The catalysts of the invention can be used in the known catalytic polymerization processes such as suspension polymerization processes, solution polymerization processes and/or gas-phase polymerization processes. Suitable reactors are, for example, continuously operated stirred reactors, loop reactors, fluidized-bed reactors or horizonally or vertically stirred powder bed reactors, tube reactors or autoclaves. Of course, the reaction can also be carried out in a plurality of reactors, connected in series. The reaction time depends critically on the reaction conditions selected in each case. It is usually in the range from 0.2 hour to 20 hours, mostly in the range from 0.5 hour to 10 hours. Advantageous pressure and temperature ranges for the polymerization reactions can vary within wide ranges and are preferably in the range from −20° C. to 300° C. and/or in the range from 1 bar to 4000 bar, depending on the polymerization method.

Preference is given to carrying out the polymerization in a reactor containing a fluidized bed or suspension of finely particulate polymer at a pressure of from 0.5 to 6 MPa (5 to 60 bar) and a temperature of from 30 to 150° C.

In solution polymerization processes, the temperature is preferably in the range from 110° C. to 250° C., more preferably in the range from 120° C. to 160° C. In solution polymerization processes, the pressure is preferably in the range up to 150 bar. In suspension polymerizations, the suspension is usually carried out in a suspension medium, preferably in an alkane. The polymerization temperatures in suspension polymerization processes are preferably in the range from 50° C. to 180° C., more preferably in the range from 65° C. to 120° C., and the pressure is preferably in the range from 5 bar to 100 bar. The order of addition of the components in the polymerization is generally not critical. It is possible either for monomer to be initially placed in the polymerization vessel and the catalyst system to be added subsequently, or for the catalyst system to be initially charged together with solvent and monomer to be added subsequently.

Antistatics can optionally be added to the polymerization. Preferred antistatics are, for example, ZnO and/or MgO, with these antistatics preferably being able to be used in amounts ranging from 0.1% by weight to 5% by weight, based on the total amount of the catalyst mixture. The water content of ZnO or MgO is preferably less than 0.5% by weight, more preferably less than 0.3% by weight, based on the respective total mass. An example of a commercial product which can be used is Stadis 450, obtainable from Dupont. Antistatics which can be used are, for example, known from DE-A-22 93 68, U.S. Pat. No. 5,026,795 and U.S. Pat. No. 4,182,810.

The polymerization can be carried out batchwise, for example in stirring autoclaves, or continuously, for example in tube reactors, preferably in loop reactors, in particular by the Phillips PF process as described in U.S. Pat. No. 3,242,150 and U.S. Pat. No. 3,248,179. Semicontinuous processes in which a mixture of all components is produced first and further monomer or monomer mixtures are metered in during the polymerization can also be used.

The polymerization and/or copolymerization is particularly preferably carried out as a gas-phase fluidized-bed process and/or suspension process. The gas-phase polymerization can also be carried out in the condensed, supercondensed or supercritical mode. If desired, different or identical polymerization processes can also be connected in series so as to form a polymerization cascade. Furthermore, an additive such as hydrogen can be used in the polymerization processes to regulate the polymer properties. If desired, hydrogen can be used as molecular weight regulator.

The catalysts of the invention are of interest for the preparation of ethylene homopolymers and ethylene-α-olefin copolymers. The polymers which can be prepared according to the invention have a high puncture resistance, high parison stability and high ESCR, with the molar mass distribution remaining comparatively narrow at the same time. The field of application of these polymers preferably extends to films, pipes and hollow bodies. The density of the ethylene homopolymers or copolymers which can be prepared using the catalyst of the invention ranges from 0.91 to 0.97 g/cm³, preferably from 0.92 to 0.965 g/cm³, particularly preferably from 0.93 to 0.962 g/cm³. The melt flow index MFR₂ of the polymers is generally from 0.01 to 50 g/10 min, preferably from 0.1 to 5 g/10 min, in particular from 0.2 to 2 g/10 min. The MFR₂₁ of the polymers is generally from 1 to 5000 g/10 min, preferably from 1.5 to 50 g/10 min, in particular from 2 to 25 g/10 min.

### EXAMPLES

The physical parameters of the catalyst or polymers were determined by the following methods:
Density ISO 1183-1
Molar mass distribution M_{w}/Mₙ, high-temperature gel permeation chromatography using a method based on DIN 55672 using 1,2,4-trichlorobenzene as solvent, a flow of 1 ml/min at 140° C. Calibration was carried out using PE standards on a Waters 150 C.
Pore volume: nitrogen adsorption using the BET technique
Surface area: nitrogen adsorption using the BET technique (S. Brunnauer et al., J of Am. Chem. Soc. 60, p. 209-319, 1929)
MFR₂, MFR₂₁ Melt flow rate in accordance with ISO 1133 at a temperature of 190° C. and under a load of 2.16 or 21.6 kg.
Puncture resistance: Dart drop impact on 20 μm films in accordance with ASTM 1709 A
ESCR: (environmental stress cracking resistance). The measurement was carried out as described in detail in the German patent application DE 10 2004 0205248, by fixing disk-shaped test specimens (produced from a pressed plate, diameter 38 mm, thickness 1 mm, scored on one side, with a notch 20 mm long and 200 μm deep) on a hollow stainless steel cylinder open at the top. The discs with the hollow cylinder are then dipped into a 5% strength aqueous solution of Lutensol FSA at 80° C., and the disk-shaped test specimens are subjected to a gas pressure of 3 bar via the hollow cylinder. The time to the occurrence of stress cracks which cause a decrease in pressure in the hollow cylinder is measured. Each measured value is the mean of 5 individual measurements.

The catalysts for the examples described below were prepared by impregnation of the respective silica gel supports with appropriate metal compounds. Zinc nitrate was used as zinc compound, and the hydrolysis-sensitive titanium isopropoxide served as titanium compound (comparative example). Chromium was used in the form of chromium(III) nitrate nonahydrate. Impregnation of the zinc-doped catalysts was carried out together with the chromium from a methanolic solution in one step. Impregnation of the titanized catalysts was carried out in a two-stage process, by firstly carrying out impregnation with titanium isopropoxide in heptane, distilling off the solvent and, in the second step, carrying out renewed impregnation with a methanolic chromium nitrate nonahydrate solution. The dried catalyst precursors were calcined without further additions in a fluidized-bed furnace, firstly in a stream of nitrogen and above 300° C. in a stream of air. The activation temperature was in each case held for 5 hours, and the catalyst was subsequently cooled and from 300° C. cooled further in a stream of nitrogen.

The polymerization was carried out in a continuous gas-phase fluidized-bed reactor at an output of 50 kg/h under the conditions indicated in the tables.

The granulation of the products for the ESCR test was carried out on a minicompounder PTW 16 from Haake at 200° C. and an output of 2 kg/h.

The products prepared for film testing were granulated at 200° C. under protective gas on a ZSK 40. Processing to produce films was carried out on a blown film plant from W&H provided with a 60/25D extruder. The film parison at a blow-up ratio of 1:2 was qualitatively classified as unstable as soon as it began to pulse (known as pumping).

The results of the polymerization and product tests are summarized in Tables 1 and 2.

Comparison of the examples shows that high puncture resistances, high parison stability and high ESCR can be achieved using the zinc-doped catalysts, with the molar mass distribution remaining comparably narrow at the same time.

TABLE 1

| Example | | 1 | 2 | C1 | C2 | C3 | C4 |
|---|---|---|---|---|---|---|---|
| Support | Type | spray- | spray- | spray- | spray- | spray- | spray- |
| | | dried | dried | dried | dried | dried | dried |
| | Pore volume [ml/g] | 1.5 | 1.5 | 1.5 | 1.5 | 1.5 | 1.5 |
| | Surface area [m²/g] | 300 | 300 | 300 | 300 | 300 | 300 |
| Catalyst | Cr content | 1 | 1 | 1 | 0.75 | 0.7 | 0.7 |
| | [% by weight] | | | | | | |
| | Ti content | 0 | 0 | 3 | 1.5 | 0 | 0 |
| | [% by weight] | | | | | | |
| | Zn content | 1 | 1 | 0 | 0 | 0 | 0 |
| | [% by weight] | | | | | | |
| | Activation temperature | 550 | 550 | 550 | 550 | 550 | 550 |
| | [° C.] | | | | | | |
| Reactor data | Reactor temperature | 108.5 | 108.8 | 105 | 108.6 | 106 | 107 |
| | [° C.] | | | | | | |
| | Ethene partial pressure | 10.8 | 10.8 | 10.6 | 10.8 | 10 | 10 |
| | [bar] | | | | | | |
| | Hexene | 0.78 | 0.76 | 0.99 | 0.82 | 0.93 | 0.91 |
| | [% by volume] | | | | | | |
| | Cocatalyst | 5 | 5 | 7 | 6 | 10 | 10 |
| | [ppm] | | | | | | |
| | Antistatic | 3 | 3 | 3 | 3 | 3 | 3 |
| | [ppm] | | | | | | |
| Product | MFR₂₁ [g/10 min] | 11.8 | 10.5 | 13.8 | 12.1 | 10.1 | 11.2 |
| properties | Density | 0.9331 | 0.9323 | 0.9335 | 0.9322 | 0.9318 | 0.9313 |
| | [g/cm³] | | | | | | |
| | Polydispersity | 27.8 | 27.5 | 32 | 21.6 | 20.5 | 21.3 |
| Film properties | Dart drop impact [g] | 213 | 199 | 222 | 209 | 198 | 194 |
| (thickness 20 μm) | Pumping at a blow-up | no | no | yes | yes | yes | yes |
| | ratio of 1:2 | | | | | | |
| | Melt temperature | 230 | 231 | 230 | 231 | 236 | 237 |
| | [° C.] | | | | | | |
| | Melt pressure [MPa] | 42.7 | 42.2 | 41.0 | 41.9 | 44.4 | 41.1 |

TABLE 2

| Example | | 3 | 4 | C5 | C6 | C7 | C8 |
|---|---|---|---|---|---|---|---|
| Support | Type | granular | granular | granular | granular | granular | granular |
| | Pore volume [ml/g] | 1.7 | 1.7 | 1.7 | 1.7 | 1.7 | 1.7 |
| | Surface area [m²/g] | 290 | 290 | 290 | 290 | 290 | 290 |
| Catalyst | Cr content | 1 | 1 | 0.7 | 0.7 | 0.3 | 0.3 |
| | [% by weight] | | | | | | |
| | Ti content | 0 | 0 | 1 | 1 | 0 | 0 |
| | [% by weight] | | | | | | |
| | Zn content | 1 | 1 | 0 | 0 | 0 | 0 |
| | [% by weight] | | | | | | |
| | Activation | 600 | 600 | 650 | 650 | 750 | 750 |
| | temperature [° C.] | | | | | | |
| Reactor data | Reactor temperature | 113 | 113 | 111.8 | 111.8 | 112.22 | 112.21 |
| | [° C.] | | | | | | |
| | C2 partial pressure | 10.8 | 10.8 | 11 | 11 | 10.8 | 10.8 |
| | [bar] | | | | | | |
| | C6 concentration | 0.38 | 0.49 | 0.4 | 0.4 | 0.33 | 0.34 |
| | Cocatalyst | 5 | 5 | 10 | 10 | 8 | 8 |
| | [ppm] | | | | | | |
| | Antistatic | 3 | 3 | 4 | 4 | 3 | 3 |
| | [ppm] | | | | | | |
| Product properties | MFR₂₁ [g/10 min] | 19.9 | 18.3 | 22.5 | 23.6 | 22.3 | 21.6 |
| | Density | 0.9385 | 0.9385 | 0.9381 | 0.9379 | 0.9390 | 0.9385 |
| | [g/cm³] | | | | | | |
| | Polydispersity | 16.5 | 14.4 | 15.5 | 14.8 | 11 | 10 |
| | ESCR [h] | 104 | 65 | 17 | 9 | 19 | 15 |

1-12. (canceled)

13. A catalyst for polymerizing and/or copolymerizing at least one olefin comprising chromium from 0.01 to 5% by weight, based on a total weight of the catalyst, the chromium being supported on a finely divided inorganic support, wherein the catalyst is obtained by concluding calcination at temperatures from 350 to 1050° C., and wherein the catalyst comprises zinc as a constituent of the finely divided inorganic support from 0.01 to 10% by weight, based on a total weight of the catalyst.

14. The catalyst according to claim 13, wherein the zinc is from 0.1 to 7% by weight.

15. The catalyst according to claim 13, wherein the zinc is deposited on a surface of the finely divided inorganic support.

16. A process for preparing a catalyst for polymerizing and/or copolymerizing at least one olefin comprising chromium from 0.01 to 5% by weight, based on a total weight of the catalyst, the chromium being supported on a finely divided inorganic support, wherein the catalyst is obtained by concluding calcination at temperatures from 350 to 1050° C., and wherein the catalyst comprises zinc as a constituent of the finely divided inorganic support from 0.01 to 10% by weight, based on a total weight of the catalyst, comprising the steps:
preparing a finely divided inorganic support;
applying a solution or suspension comprising at least one zinc compound to the finely divided inorganic support;
applying a solution or suspension comprising at least one chromium compound to the finely divided inorganic support;
optionally, drying the finely divided inorganic support; and
calcinating the finely divided inorganic support at temperatures from 350 to 1050° C.

17. The process according to claim 16, wherein the finely divided inorganic support is calcinated at a temperature from 400 to 900° C.

18. The process according to claim 16, wherein the solution or suspension comprising the at least one chromium compound and the at least one zinc compound are applied simultaneously to the finely divided inorganic support.

19. The process according to claim 16, wherein the process comprises applying a solution or suspension comprising (i) at least one chromium compound, and (ii) at least one zinc compound.

20. The process according to claim 16, wherein the at least one zinc compound is a salt of a strong acid.

21. The process according to claim 20, wherein the strong acid is zinc nitrate.

22. The process according to claim 16, wherein the at least one zinc compound is a salt of an organic acid.

23. The process according to claim 22, wherein the organic acid is zinc acetylacetonate or zinc acetate.

24. A process for polymerizing an ethylene homopolymer or an ethylene copolymer comprising up to 10% by weight of at least one C₃-C₂₀-olefin, wherein the process is carried out in presence of a catalyst comprising chromium from 0.01 to 5% by weight, based on a total weight of the catalyst, the chromium being supported on a finely divided inorganic support, wherein the catalyst is obtained by concluding calcination at temperatures from 350 to 1050° C., and wherein the catalyst comprises zinc as a constituent of the finely divided inorganic support from 0.01 to 10% by weight, based on a total weight of the catalyst, and the process is carried out at a temperature ranging from 30 to 150° C., and under a pressure ranging from 0.2 to 15 MPa.

25. An ethylene homopolymer or ethylene copolymer obtained by a process carried out in presence of a catalyst comprising chromium from 0.01 to 5% by weight, based on a total weight of the catalyst, the chromium being supported on a finely divided inorganic support, wherein the catalyst is obtained by concluding calcination at temperatures from 350 to 1050° C., and wherein the catalyst comprises zinc as a constituent of the finely divided inorganic support from 0.01 to 10% by weight, based on a total weight of the catalyst, and the process is carried out at a temperature ranging from 30 to 150° C., and under a pressure ranging from 0.2 to 15 MPa.

26. The ethylene homopolymer or copolymer according to claim 25, comprising a density from 0.92 to 0.965 g/cm³, a melt flow rate MFR₂ from 0.1 to 5 g/10 min, and a melt flow rate MFR₂₁ from 1.5 to 50 g/10 min.

27. The ethylene homopolymer or copolymer according to claim 26, comprising a density from 0.93 to 0.962 g/cm³.

28. The ethylene homopolymer or copolymer according to claim 26, comprising a melt flow rate MFR₂ from 0.2 to 2 g/10 min.

29. The ethylene homopolymer or copolymer according to claim 26, comprising a melt flow rate MFR₂₁ from 2 to 25 g/10 min.

30. A film, pipe, hollow body, or combination thereof comprising an ethylene homopolymer or ethylene copolymer obtained by a process carried out in presence of a catalyst comprising chromium from 0.01 to 5% by weight, based on a total weight of the catalyst, the chromium being supported on a finely divided inorganic support, wherein the catalyst is obtained by concluding calcination at temperatures from 350 to 1050° C., and wherein the catalyst comprises zinc as a constituent of the finely divided inorganic support from 0.01 to 10% by weight, based on a total weight of the catalyst, and the process is carried out at a temperature ranging from 30 to 150° C., and under a pressure ranging from 0.2 to 15 MPa.
